(19) United States
(12) Patent Application Publication
(10) Pub. No.: US 2003/0215038 A1
(43) Pub. Date: Nov. 20, 2003

(54) Jitter-resistant serial data receiving circuit

(76) Inventors: Takuya Hirade, Tokyo (JP); Hiroomi Nakao, Tokyo (JP)

Correspondence Address: BURNS, DOANE, SWECKER & MATHIS, L.L.P., P.O. Box 1404, Alexandria, VA, 22313-1404, US

(21) Appl. No.: 10/272,948

(22) Filed: Oct. 18, 2002

(30) Foreign Application Priority Data
May 17, 2002 (JP) 2002-143614

(51) Int. Cl. H04L 7/00; H04L 25/00; H04L 25/40

(52) U.S. Cl. 375/372

(57) ABSTRACT

A serial data receiving circuit includes a serial-to-parallel converter and a data selector. The serial-to-parallel converter converts the oversampled data fed from an oversampling circuit to m×n bit parallel data. The data selector, receiving (m×n+α) bits of data simultaneously from the serial-to-parallel converter, where α is a natural number indicating the bit number of the data selected from the previous and/or subsequent oversampled data to be added to the m×n-bit data, evaluates all the (m×n+α) bits of data as candidates to be likely selected, and outputs the n-bit parallel data from the (m×n+α) bits of data. The serial data receiving circuit can output the right data in spite of jitter included in the data or clock signal.

### BACKGROUND OF THE INVENTION

1. Field of the Invention

The present invention relates to a serial data receiving circuit for receiving high-speed serial data.

2. Description of Related Art

FIG. 13 is a block diagram showing a configuration of a conventional serial data receiving circuit. In this figure, the reference numeral 1 designates an oversampling circuit, 2 designates a serial-to-parallel converter and 3 designates a data selector.

Next, the operation of the conventional serial data receiving circuit will be described.

Many systems for receiving high-speed serial data have the three functional blocks as shown in FIG. 13. The oversampling circuit 1 samples the input serial data m times per data, where m is greater than one. The serial-to-parallel converter 2 converts the oversampled data to m×n-bit parallel data, where n≧1. The data selector 3 selects one of m bits of each parallel data, and outputs n-bit parallel data. Such a conventional technique is disclosed in U.S. Pat. No. 5,905,769, for example.

With the foregoing configuration, the conventional serial data receiving circuit selects one of m bits of oversampled data, and outputs it. This means that the conventional serial data receiving circuit makes a decision as to whether each input serial data is “0” or “1” from m bits of data, and outputs the decision result.

Since each data is oversampled m times, the oversampling of the data is most accurate when all the m bits of data are identical. It is expected that the most reliable data is to be output from the oversampled data. If it is known in advance which position of the m-bit data unit gives the most reliable data, it is likely that the right data can be output. However, the position of the most reliable data can fluctuate because of jitter of a clock signal or data, in which case a problem arises that it is difficult to output the right data.

### SUMMARY OF THE INVENTION

The present invention is implemented to solve the foregoing problem. It is therefore an object of the present invention to provide a serial data receiving circuit capable of outputting the right data in spite of the jitter of the data or clock signal.

According to an aspect of the present invention, there is provided a serial data receiving circuit including a data selector that receives (m×n+α) bits of data simultaneously, evaluates them all as the candidates to be likely selected, and outputs n-bit parallel data from among these data. Thus, it can produce a right n-bit output in spite of jitter in the data or clock signal by adding the previous and/or subsequent a bits of data to the m×n bits of data, and by evaluating them all as the candidates to be likely selected.

### BRIEF DESCRIPTION OF THE DRAWINGS

FIG. 1 is a block diagram showing a configuration of an embodiment 1 of a serial data receiving circuit in accordance with the present invention;

FIG. 2 is a block diagram showing a configuration of the data selector of an embodiment 2 in accordance with the present invention;

FIG. 3 is a schematic diagram illustrating an example of the processing of the embodiment 2 of the serial data receiving circuit in accordance with the present invention;

FIG. 4 is a schematic diagram illustrating another example of the processing of the embodiment 2 of the serial data receiving circuit in accordance with the present invention;

FIG. 5 is a schematic diagram illustrating still another example of the processing of the embodiment 2 of the serial data receiving circuit in accordance with the present invention;

FIG. 6 is a schematic diagram illustrating another example of the processing of the embodiment 2 of the serial data receiving circuit in accordance with the present invention;

FIG. 7 is a block diagram showing a configuration of the data selector of an embodiment 3 in accordance with the present invention;

FIG. 8 is a block diagram showing a configuration of the data selector of an embodiment 4 in accordance with the present invention;

FIG. 9 is a schematic diagram illustrating a problem of the processing of the embodiment 2 of the serial data receiving circuit in accordance with the present invention;

FIG. 10 is a schematic diagram illustrating the problem of the processing of the embodiment 2 of the serial data receiving circuit in accordance with the present invention;

FIG. 11 is a schematic diagram illustrating an example of the processing of the embodiment 4 of the serial data receiving circuit in accordance with the present invention;

FIG. 12 is a schematic diagram illustrating the example of the processing of the embodiment 4 of the serial data receiving circuit in accordance with the present invention; and

FIG. 13 is a block diagram showing a configuration of a conventional serial data receiving circuit.

### DETAILED DESCRIPTION OF THE PREFERRED EMBODIMENTS

The invention will now be described with reference to the accompanying drawings.

Embodiment 1

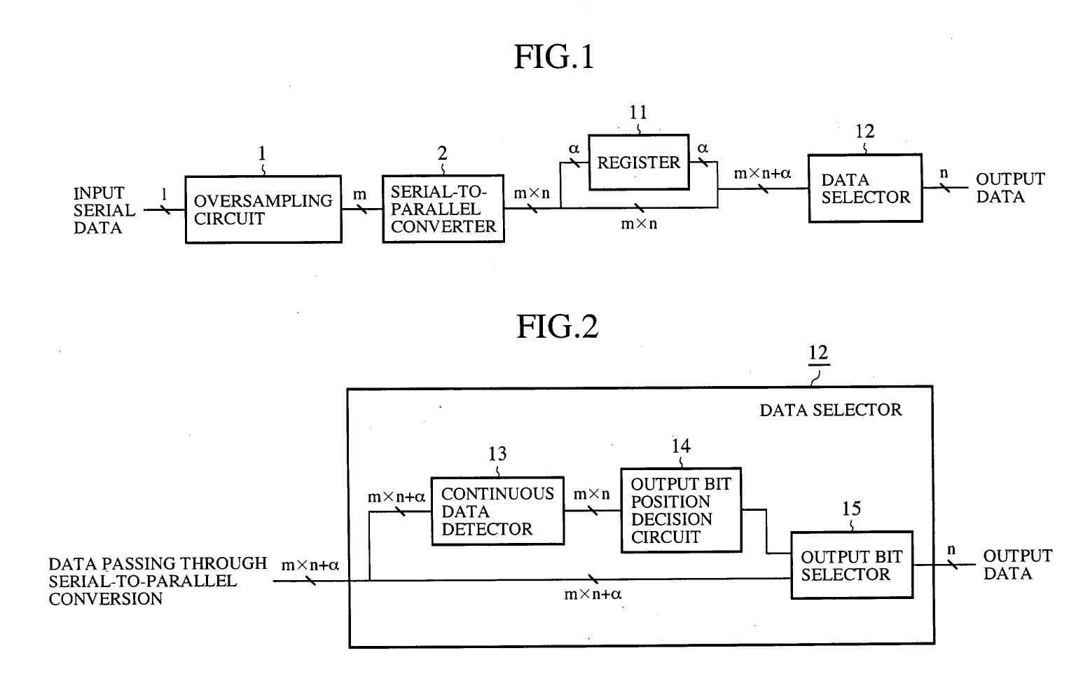

FIG. 1 is a block diagram showing a configuration of an embodiment 1 of the serial data receiving circuit in accordance with the present invention. In this figure, the reference numeral 1 designates an oversampling circuit for sampling input serial data m time per data, where m is an integer greater than one; and 2 designates a serial-to-parallel converter for converting the oversampled data to m×n-bit parallel data, where n is an integer greater than zero.

The reference numeral 11 designates a register for holding a bits of data of the m×n data supplied from the serial-to-parallel converter 2, where a is a natural number, and for outputting the delayed α bits of data; and 12 designates a data selector for simultaneously receiving (m×n+α) bits of data obtained by adding the previous a bits of data delayed by the register 11 to the m×n data from the serial-to-parallel converter 2, for evaluating all the data as candidates likely to be selected, and for outputting n-bit parallel data from these data.

Next, the operation of the present embodiment 1 will be described.

The oversampling circuit 1 samples the input serial data m times per data. The serial-to-parallel converter 2 converts the oversampled data to m×n-bit parallel data.

The register 11 holds α bits of data among m×n data fed from the serial-to-parallel converter 2, and outputs delayed a bits of data.

The data selector 12 simultaneously receives (m×n+α) bits of data which are obtained by adding the previous a bits of data delayed by the register 11 to the m×n data fed from the serial-to-parallel converter 2, evaluates all the data as candidates to be likely selected, and outputs the n-bit parallel data from these data.

As described above, the present embodiment 1 includes the data selector 12 that receives the (m×n+a) bits of data simultaneously, evaluates them all as the candidates to be likely selected, and outputs the n-bit parallel data from among these data. Thus, the present embodiment 1 can produce right n-bit output in spite of jitter in the data or clock signal by adding the previous α bits of data to the m×n bits of data, and by evaluating them all as the candidates to be likely selected.

Although the present embodiment 1 uses the previous data as the α bits of data, this is not essential. For example, the next data can be used, or both the previous and next data can be used as the a bits of data, offering similar advantages.

Embodiment 2

FIG. 2 is a block diagram showing a configuration of a data selector of an embodiment 2 in accordance with the present invention. In this figure, the reference numeral 13 designates a continuous data detector for detecting the continuity of the data having the same value from the input (m×n+α) bits of data, and for setting a continuous decision flag when the continuity is detected; 14 designates an output bit position decision circuit for detecting n-bit positions with small data transition in response to the continuous decision flag; and 15 designates an output bit selector for selecting the data at the bit positions decided by the output bit position decision circuit 14 from the input (m×n+α) bits of data, and for outputting the selected data. The oversampling circuit 1 and serial-to-parallel converter 2 are the same as those of the foregoing embodiment 1.

Next, the operation of the present embodiment 2 will be described.

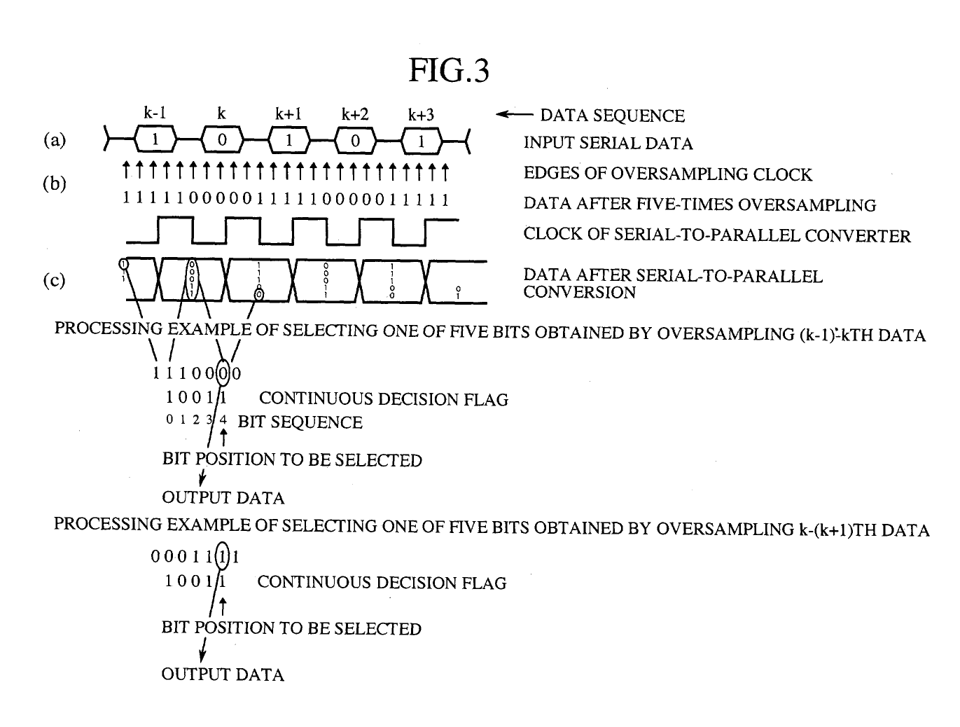

FIG. 3 is a schematic diagram illustrating an example of the processing of the embodiment 2 of the serial data receiving circuit in accordance with the present invention.

Assume that the input serial data as shown in FIG. 3(a) is supplied to the oversampling circuit 1 of the serial data receiving circuit, and the data as shown in FIG. 3(b) is produced as a result of the oversampling with m=5. The serial-to-parallel converter. 2 carries out the serial-to-parallel conversion of the data in response to the clock, and processes the data by delimiting them every five bits of data. Then, the data selector 12 selects and outputs the optimum bit, thereby decoding the data.

Although the data is processed by delimiting the data at every five bits of data, when the internal clock signal is not synchronized with the input data, the delimiters of the five bits of data are not necessarily synchronized with the input data as illustrated in FIG. 3(c).

Next, the selection of the optimum bit from the delimited five bits of data will be described. To select one of the five bits of data, it is necessary to select the most reliable data from the five bits. When three-bit consecutive identical data, the majority of five bits, is present in the five bits, the value of the continuous data is the value of the bit to be selected, and to select the middle bit of the three bits is considered to be most reliable. The continuous data detector 13 to achieve this, for example, sets up the flag 1 at the middle position of the three consecutive bits when the three consecutive identical bits are present in the five bits, but sets up flag 0 in the other cases. To set up the flag 1 at all the five bit positions, it is necessary to make a decision at seven bits. Accordingly, the decision is made at the seven bits including the m (=5) bits plus the two (α=2) bits adjacent to both ends of the m bits.

It will be reasonable to consider the data with the flag 1 are candidates of the data to be selected. As for the five bits associated with the (k−1)-kth data of FIG. 3(c), the zeroth, third and fourth bits are the candidates of the bit to be selected. When there are a plurality of the candidates of the bit to be selected, it will be reasonable to select the middle bit as the candidates of the bit to be selected. To achieve this, the output bit position decision circuit 14, considering the bit next to the fourth bit is the zeroth bit because the latter is processed next to the former, selects the fourth bit as the middle bit of the third, fourth and zeroth bits. Hence, the output bit selector 15 selects and outputs the data at the fourth bit.

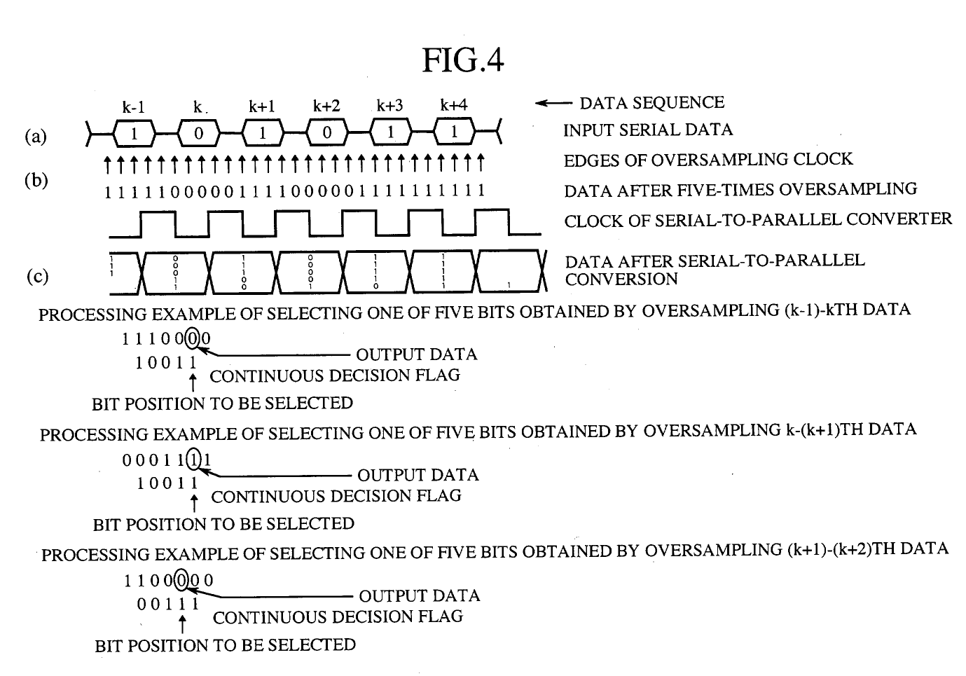

FIG. 4 is a schematic diagram illustrating another example of the processing of the embodiment 2 of the serial data receiving circuit in accordance with the present invention.

Assume that the input serial data as shown in FIG. 4(a) becomes the data as shown in FIG. 4(b) after the oversampling. In this case, as a result of the processing of the (k−1)-kth data, the fourth bit data is selected; as a result of the processing of the k-(k+1)th data, the fourth bit data is selected; and as a result of the processing of the (k+1)-(k+2)th data, the third bit data is selected. Thus selecting the third bit data in spite of the jitter enables the right output.

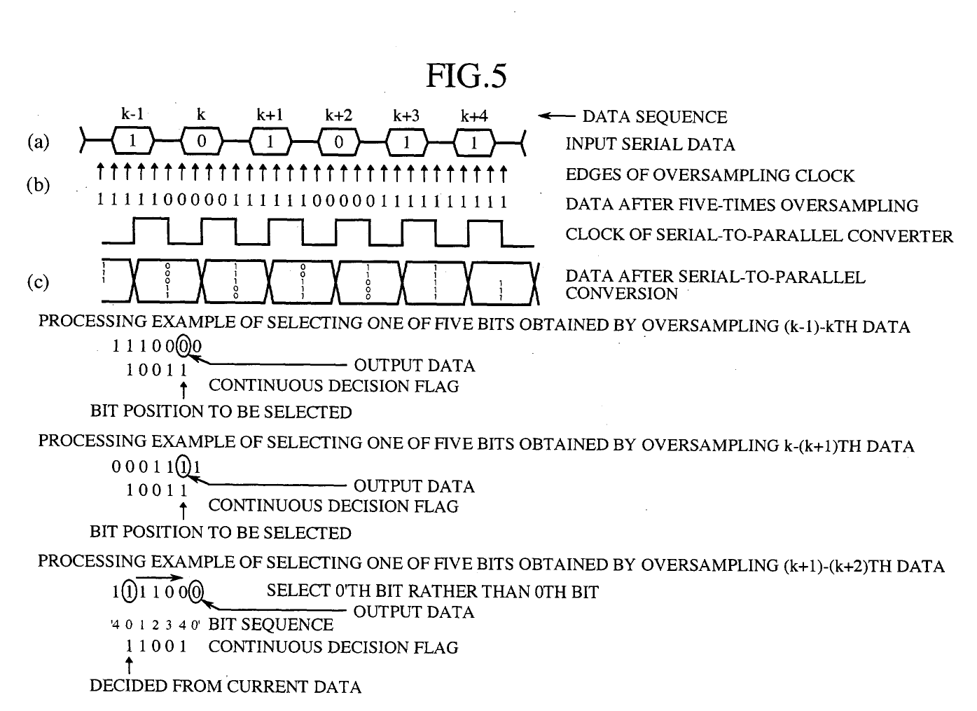

FIG. 5 is a schematic diagram illustrating still another example of the processing of the embodiment 2 of the serial data receiving circuit in accordance with the present invention.

Assume that the input serial data as shown in FIG. 5(a) becomes the data as shown in FIG. 5(b) after the oversampling. In this case, as a result of the processing of the (k−1)-kth data, the fourth bit data is selected; as a result of the processing of the k-(k+1)th data, the fourth bit data is selected; and as a result of the processing of the (k+1)-(k+2)th data, the zeroth bit data is selected. Thus selecting the zeroth bit after selecting the fourth bit will result in the double acquisition of the data because the two bits of the same data ((k+1)th data) are output.

When the candidates of the bit position to be selected is the zeroth bit or the fourth bit, it is possible to produce the right output by selecting the bit position closer to the bit position of the previous output. For example, comparing the 0th bit with the 0'th bit of FIG. 5(c), the bit closer to the fourth bit, that is, the 0'th bit is selected. Thus, when the candidates of the bit position to be selected is the zeroth bit or fourth bit, the right output can be obtained by enabling the 0'th bit or '4th bit to be output.

As for the (k+2)-(k+3)th processing, the right output can be obtained by selecting the 0'th bit.

In this way, it is possible for the jitter-resistant system to produce the right output. In the present example, the double acquisition of the data can be avoided which can occur when the bit position to be selected is shifted from the fourth bit to the zeroth bit. Although not shown in the example, the data omission is also avoidable which can occur when the bit position to be selected is shifted from the zeroth bit to the fourth bit.

In, the present example, the parameters are set at m=5, n=1 and α=2. In other words, it employs five-times oversampling, selects one of the three consecutive identical data, and adds to the previous five-bit output the two bits adjacent thereto. These conditions, however, are not essential, and are variable.

Thus, the present embodiment 2 can achieve the processing without the bit omission or double acquisition of the data. As a result, it can output data at highly reliable bit positions in spite of the noise or jitter.

In the foregoing description in connection with FIGS. 3-5, the processing is based on the oversampling number m and the two bits adjacent to the m-bit data. This means that the serial-to-parallel converter 2 carries out the parallel conversion of the data on the basis of the oversampling number m. Accordingly, when the serial-to-parallel conversion is carried out on an m×n basis, the parallel processing is performed on an n by n basis. As a result, the present embodiment 2 can reduce the clock frequency by a factor of n as compared with the foregoing embodiment 1, thereby making it possible to reduce the frequency with keeping the same processing time.

Thus, an example employing the variables m=5, n=4 and α=2 will be described next.

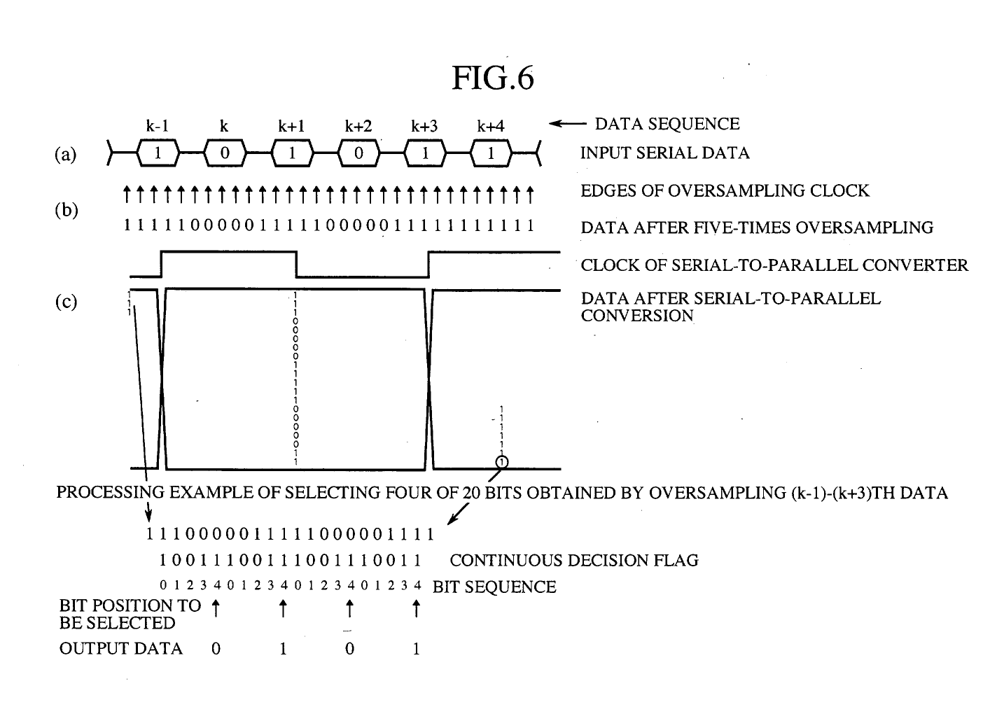

FIG. 6 is a schematic diagram illustrating such an example of the processing of the embodiment 2 of the serial data receiving circuit in accordance with the present invention.

Assume that the input serial data as illustrated in FIG. 6(a) is input, that the data as illustrated in FIG. 6(b) is produced as a result of the oversampling, and that the data as illustrated in FIG. 6(c) is produced as a result of the serial-to-parallel conversion of the oversampled data.

As for the 22-bit data shown in FIG. 6(c), a decision is made as to whether three consecutive bits are each identical or not to search for the highly reliable bit positions. In this example, as to the third, fourth and zeroth bits, the continuous decision flag is “1” for all the four units. Thus, the data is likely to be highly reliable. In this case, a decision is made that the third, fourth and zeroth bits are continuous, and the middle fourth bits are output.

In this way, the output bit position decision circuit 14 makes a decision as to which bit is most reliable (which bit has the continuous decision flag “1” most frequently) in the four units when deciding the bit position, and outputs the data at the same position for all the four units. Accordingly, as for the four processing units, it is possible to eliminate the double acquisition of the data and the data omission. As a result, the present embodiment can output the data at highly reliable bit positions even if incorrect data due to noise is included in the four units.

Although the foregoing description is made by way of example employing the oversampling number of five (m=5) and the parallel processing of four units (n=4), they can be varied easily.

As described above, the present embodiment 2 is configured such that its data selector 12 comprises the output bit position decision circuit 14 for detecting the n-bit positions with small data transition from the input (m×n+α) bits of data in accordance with the continuity of the data with the same value, and the output bit selector 15 for selecting from the input (m×n+α) bits of data the data at the bit positions decided by the output bit position decision circuit 14 and outputs the selected data. Thus, the present embodiment 2 can detect the n-bit positions with small data transition to select the correct data to be output, thereby making it possible to output the right n-bit data in spite of the noise or jitter.

Embodiment 3

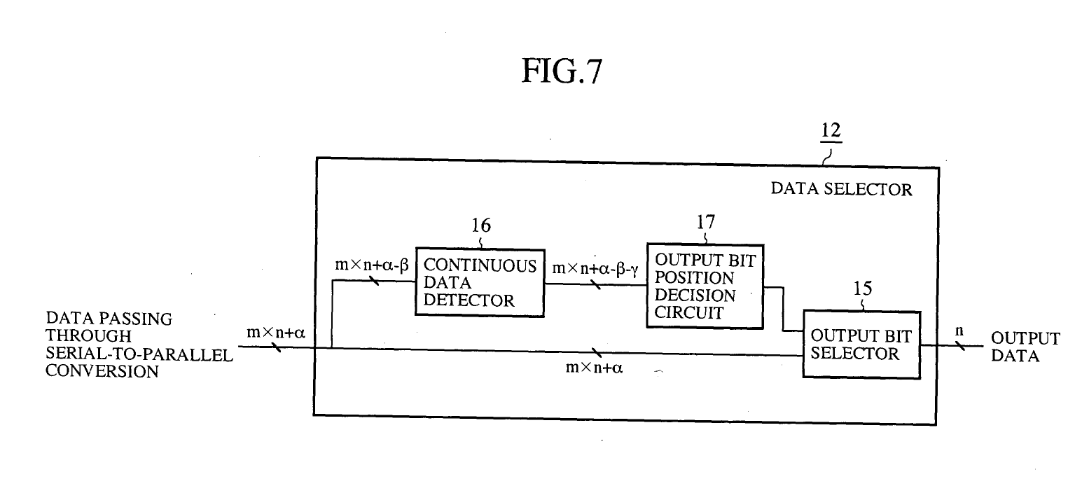

FIG. 7 is a block diagram showing a configuration of the data selector of an embodiment 3 in accordance with the present invention. In this figure, the reference numeral 16 designates a continuous data detector for detecting, as a condition for inhibiting a sudden shift of a highly reliable bit position, the continuity of the data having the same value from the input ((m×n+α)−β) bits of data, where β is a given natural number, and for setting a continuous decision flag when the continuity is detected; 17 designates an output bit position decision circuit for detecting n-bit positions with small data transition in response to the continuous decision flag; and 15 designates an output bit selector for selecting the data at the bit positions decided by the output bit position decision circuit 14 from the input (m×n+α) bits of data, and for outputting the selected data. The oversampling circuit 1 and serial-to-parallel converter 2 are the same as those of the foregoing embodiment 1.

Next, the operation of the present embodiment 3 will be described.

The continuous data detector 16 detects, as the condition for inhibiting a sudden shift of the highly reliable bit position, the continuity of the data having the same value from the input ((m×n+α)−β) bits of data, and sets the continuous decision flag when the continuity is detected. The output bit position decision circuit 17 detects the n-bit positions with small data transition in response to the continuous decision flag. The output bit selector 15 selects the data at the bit positions decided by the output bit position decision circuit 17 from among the input (m×n+α) bits of data, and outputs the selected data.

As described above, the present embodiment 3 is configured such that its data selector 12 comprises the output bit position decision circuit 17 for detecting the n-bit positions with small data transition from only a part of the input (m×n+α) bits of data in accordance with the continuity of the data with the same value, and the output bit selector 15 for selecting from the input (m×n+α) bits of data the data at the bit positions decided by the output bit position decision circuit 17 and outputs the selected data. Thus, the present embodiment 3 can detect the n-bit positions with small data transition to select the right data to be output, thereby making it possible to output the correct n-bit data in spite of the noise or jitter. In addition, imposing the condition of inhibiting the sudden shift of the highly reliable bit position makes it possible to detect the n-bit positions with small data transition from only the part of the input (m×n+α) bits of data, thereby being able to reduce the circuit scale.

Embodiment 4

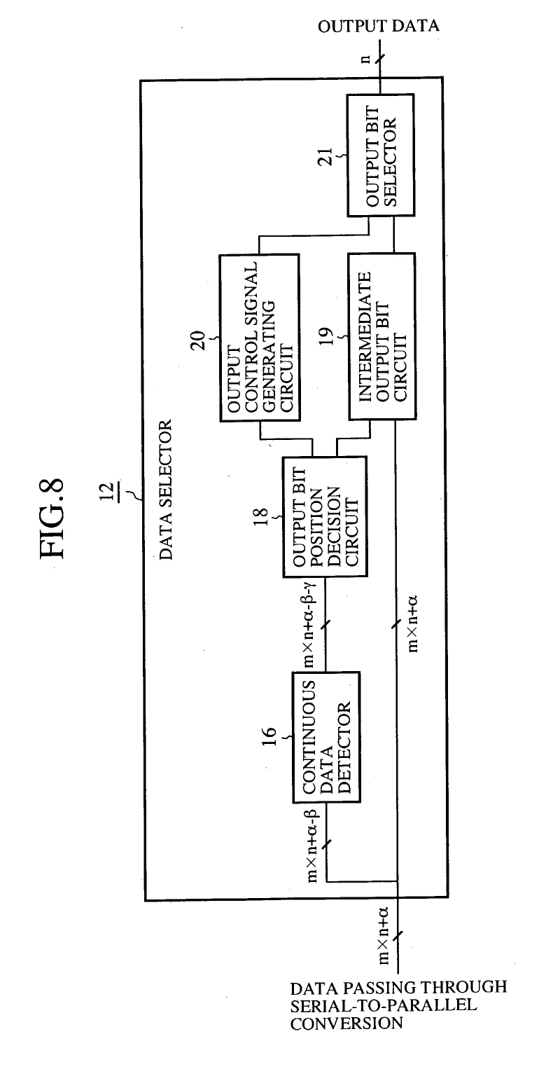

FIG. 8 is a block diagram showing a configuration of the data selector of an embodiment 4 in accordance with the present invention. In this figure, the reference numeral 16 designates a continuous data detector for detecting, as a condition for inhibiting a sudden shift of a highly reliable bit position, the continuity of the data having the same value from the input ((m×n+α)−β) bits of data, where β is a given natural number, and for setting a continuous decision flag when the continuity is detected; 18 designates an output bit position decision circuit for detecting central, previous and subsequent n-bit positions with small data transition in response to the continuous decision flag; 19 designates an intermediate output bit circuit for intermediately outputting, from among the input (m×n+α) bits of data, the data at the central, previous and subsequent n-bit positions decided by the output bit position decision circuit 18; 20 designates an output control signal generating circuit that holds one of the central, previous and subsequent n-bit positions previously selected, and generates a flag (control signal) for deciding one of the central, previous and subsequent n-bit positions to be currently selected in accordance with the comparison result between the previous and the current n-bit positions decided by the output bit position decision circuit 18; and 21 designates an output bit selector for selecting, from the intermediate output fed from the intermediate output bit circuit 19, the data at the bit positions corresponding to the flag fed from the output control signal generating circuit 20, and for outputting the selected data. The oversampling circuit 1 and serial-to-parallel converter 2 have the same configuration as those of the foregoing embodiment 1.

Next, the operation of the present embodiment 4 will be described.

The example described in the foregoing embodiment 2 can carry out the process without bringing about the bit omission or double acquisition of the data in the system suffered from jitter. However, to prevent the bit omission or double acquisition of the datain the system suffered from large jitter, it is sometimes insufficient to add only two bits, each of which is placed at the previous and subsequent position as described in the foregoing embodiment 2. Hence, it becomes necessary to add more bits to prevent them. In such a case, the processing of the foregoing embodiment 2 will bring about an increase of the circuit scale, and the reduction in the processing speed.

A method to solve such a problem will be described by way of example.

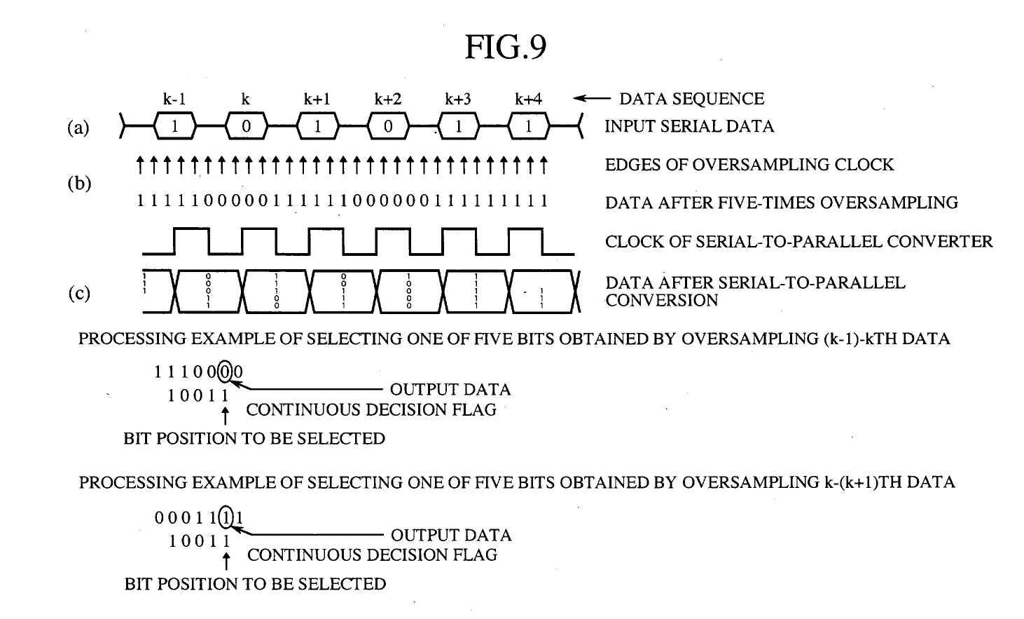

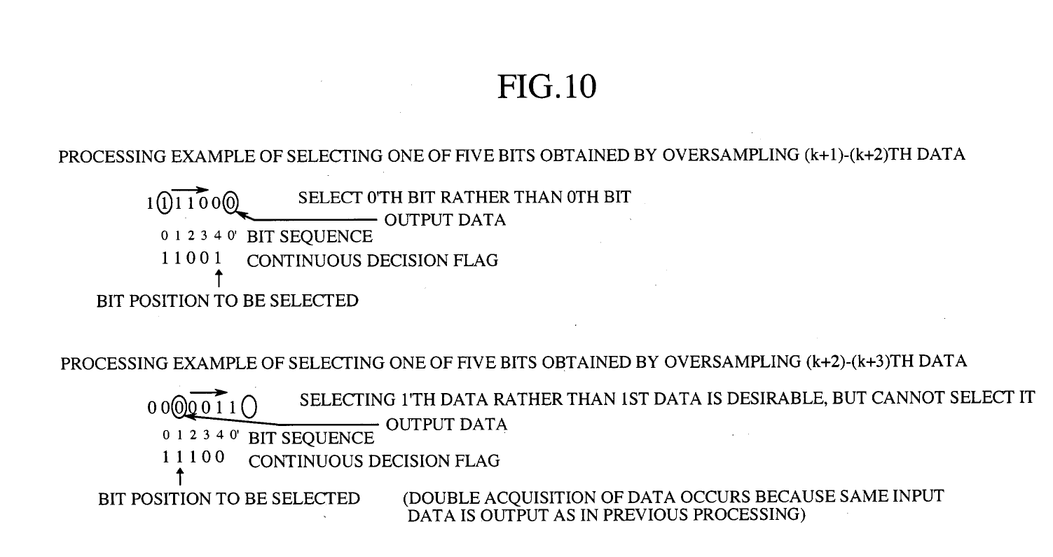

FIGS. 9 and 10 are schematic diagrams illustrating the problem of the processing of the foregoing embodiment 2 of the serial data receiving circuit in accordance with the present invention. Let us consider the case as illustrated in FIGS. 9 and 10 where the bit to be selected is further shifted to the next first bit (1'th bit) because of jitter, which is not expected in the foregoing embodiment 2. The foregoing embodiment 2 can select the right data without problem when the bit to be selected is shifted to the 0'th bit. This is because the data unit to be processed consists of the seven bits including the 5-bit data plus the two bits adjacent thereto. To select the 0'th bit means to select the end bit of the seven bits. However, when the bit position to be selected is shifted to the 1'th bit, the correct selection cannot be achieved by the 7-bit processing. In other words, the 1'th bit cannot be output, thereby making it impossible to follow the jitter, and bringing about the double acquisition of the data as illustrated at the bottom of FIG. 10. The problem can be solved easily by increasing the number of bits of the data unit to be processed from 5+2 bits to 5+4 or 5+6 bits (that is, increase the number of bit positions to be selected from 5 to 7 or 9), and by selecting the right bit from that data, for example. This, however, will increase the circuit scale and reduce the processing speed.

One method of solving the problem is as follows. As for the bit positions to be selected, the method decides them by processing the data unit consisting of the seven bits including the five bits plus the two bits adjacent thereto as in the foregoing embodiment 2. In such a system, the sudden change of the highly reliable bit position is strictly inhibited, and the right output can be produced by deciding the highly reliable bit positions using only part of the input data rather than all the input data. Since the input data undergoes the five-times oversampling, it is reasonable to think that the highly reliable data occurs at every 5-bit interval. Accordingly, if the highly reliable data does not appear at every 5-bit interval, another more reliable bit position that appears at every 5-bit interval must be decided.

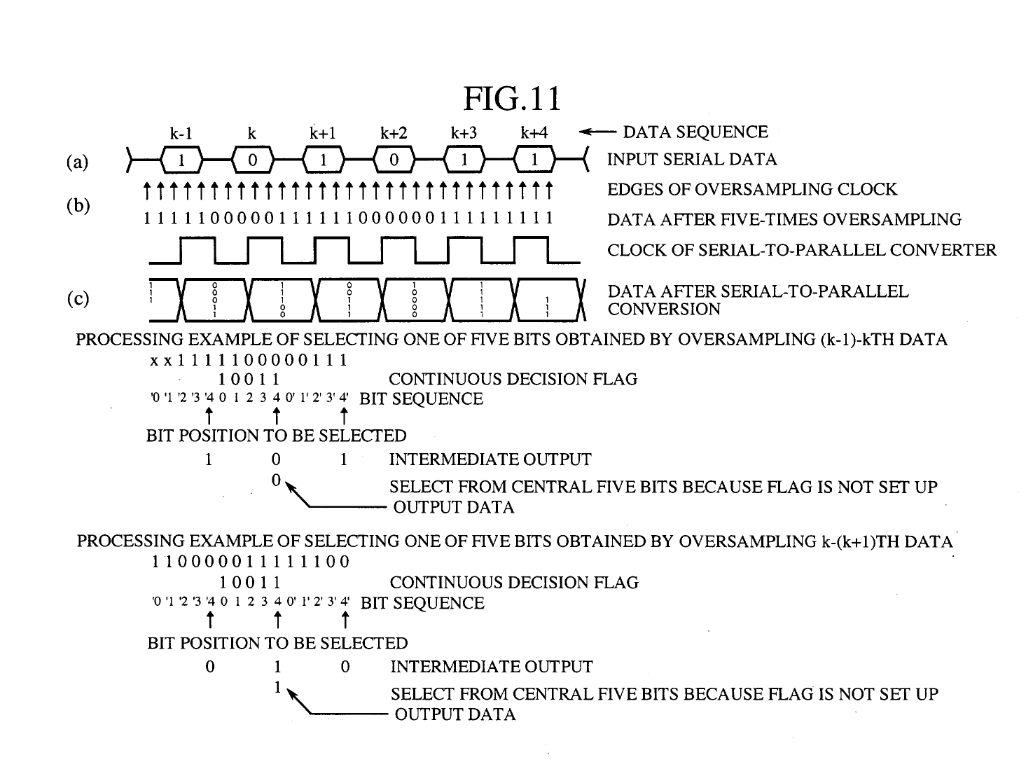

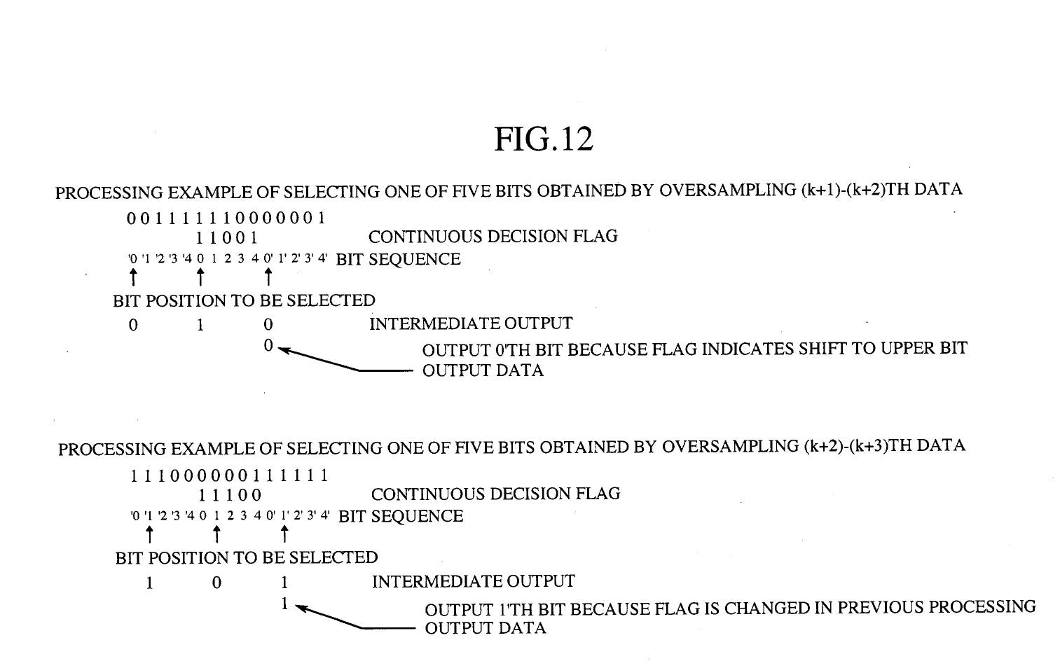

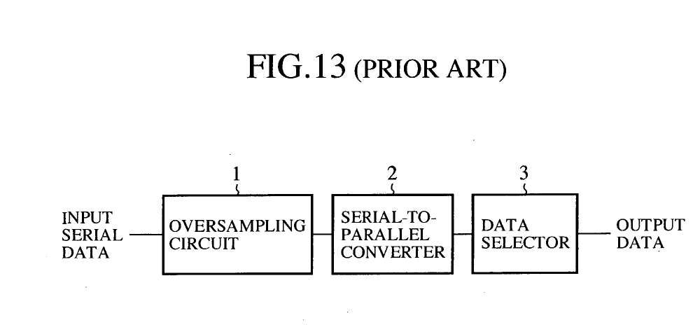

FIGS. 11 and 12 are schematic diagrams illustrating the processing of the embodiment 4 of the serial data receiving circuit in accordance with the present invention. Assume that the input serial data as illustrated in FIG. 11(a) is input. In this case, the bit position to be selected becomes the fourth bit for the (k−1)-kth data; the fourth bit for the k-(k+1)th data; and the zeroth bit for the (k+1)-(k+2)th data. In addition, the allowable shift amount of the bit to be selected under the jitter is determined in advance. Assume that the allowable shift amount is five bits before and after the current data unit. In other words, the output bit position decision circuit 18 can select the output data not only from the central five bits, but also from the previous and subsequent five bits, and the intermediate output bit circuit 19 intermediately outputs, from the input (m×n+α) bits of data, the data at the central, previous and subsequent bit positions determined by the output bit position decision circuit 18.

The output control signal generating circuit 20 generates the flag (control signal), according to which the output bit selector 21 selects the final output bit from the intermediate output. Specifically, the output control signal generating circuit 20 holds one of the central, previous and subsequent positions and its bit position at the previous final output, and generates a flag for deciding one of the central, previous and subsequent positions to be currently selected in accordance with the comparison result between the previous and current bit positions decided by the output bit position decision circuit 18. For example, when the bit to be selected is maintained in the central five bits, the output control signal generating circuit 20 does not generate the flag. In contrast, when the bit to be selected is the fourth bit, and is shifted to the zeroth bit at the next processing, the output control signal generating circuit 20 sets up the flag indicating that the bit to be selected is shifted from the central five bits in the seven bits toward the upper bit.

When the flag is not set up, the data at the position corresponding the central five bits in the intermediate outputs is output. Thus, the output bit selector 21 selects the intermediate output from among the central five bits. In contrast, when the flag is set up, the data at the position corresponding to the subsequent five bits in the intermediate outputs is output. Thus, the output bit selector 21 selects the intermediate output of the subsequent five bits, that is, the 0'th bit to be output. As for the (k+2)-(k+3)th data, the 1'th bit is selected to be output. Although the 1'th bit can be output in this way, the processing speed is not reduced.

Likewise, although not shown in the example, when the bit to be selected shifts from the zeroth bit to the fourth bit, the data at the position corresponding to the previous five bits in the intermediate outputs is selected and output by setting up the flag indicating the bit shift toward the preceding direction.

In this way, the shift amount of the bit to be selected is allowed up to 15 bits with maintaining the number of the bit positions to be selected at five, thereby implementing a jitter-resistant circuit with a small circuit scale. Thus, in spite of the jitter of the clock signal or the like, it can output the data at bit positions that are expected to be highly reliable. Although the present embodiment 4 sets the allowable shift amount of the bit to be selected at five bits before and after the current data unit, it is only an example. The number of the bits can be increased or decreased in accordance with the allowable shift amount of the system, and such a system can be implemented without difficulty.

The present embodiment 4 is configured such that the bit position is selected from the m+α bits, where m is the oversampling number and a is the number of bits adjacent to the m bits. The configuration can be modified as in the foregoing embodiment 2. Specifically, the serial-to-parallel conversion generates m×n parallel data, and the data selector 12 selects the data from among the (m×n+α) data, thereby making it possible to reduce the clock frequency by a factor of n, and carrying out the processing at a lower frequency with maintaining the processing time.

In addition, the double acquisition of the data or the data omission can be prevented by intermediately outputting the data at the same bit position for all the data processed during one clock period.

In this way, the present embodiment 4 can achieve the low-speed operation, and output data at the bit positions considered to be highly reliable even when the clock signal includes the jitter.

As described above, the present embodiment 4 is configured such that its data selector 12 comprises the output bit position decision circuit 18 for detecting, as the condition for inhibiting the sudden shift of the highly reliable bit position, the central, previous and subsequent n-bit positions with small data transition from only a part of the input (m×n+α) bits of data in accordance with the continuity of the data with the same value; the output control signal generating circuit 20 that generates the flag (control signal) for deciding one of the central, previous and subsequent n-bit positions to be currently selected in accordance with the comparison result between the previous and the current n-bit positions decided by the output bit position decision circuit 18; and the output bit selector 21 for selecting, from the input (m×n+α) bits of data, the data at the bit position corresponding to the flag, and for outputting the selected data. Thus, the present embodiment 4 can detect the n-bit positions with small data transition, and select the data to be output, thereby making it possible to output the correct n-bit data in spite of the noise or jitter. In addition, imposing the condition of inhibiting the sudden shift of the highly reliable bit position makes it possible to detect the n-bit positions with small data transition from only the part of the input (m×n+α) bits of data, thereby being able to prevent the increase in the circuit scale and the reduction in the processing speed.

What is claimed is:

1. A serial data receiving circuit comprising:
an oversampling circuit for sampling input serial data m times per data, where m is an integer greater than one;
a serial-to-parallel converter for converting the oversampled data fed from said oversampling circuit to m×n-bit parallel data, where n is an integer greater than zero; and
a data selector for simultaneously receiving (m×n+α) bits of data from said serial-to-parallel converter, where a is a natural number indicating the bit number of data selected from at least one of previous and subsequent oversampled data to be added to the m×n-bit data, and for outputting n-bit parallel data from among the (m×n+α) bits, all of which are evaluated as candidates to be likely selected.

2. The serial data receiving circuit according to claim 1, wherein said data selector comprises:
an output bit position decision circuit for detecting n-bit positions with small data transition in the input (m×n+α) bits of data considering continuity of the input (m×n+α) bits of data having a same value; and
an output bit selector for selecting, from among the input (m×n+α) bits of data, the data at the bit positions decided by said output bit position decision circuit.

3. The serial data receiving circuit according to claim 1, wherein said data selector comprises:
an output bit position decision circuit for detecting, as a condition for inhibiting a sudden shift of a highly reliable bit position, n-bit positions with small data transition in only a part of the input (m×n+α) bits of data considering continuity of the part of the input (m×n+α) bits of data having a same value; and
an output bit selector for selecting, from among the input (m×n+α) bits of data, the data at the bit positions decided by said output bit position decision circuit.

4. The serial data receiving circuit according to claim 1, wherein said data selector comprises:
an output bit position decision circuit for detecting, as a condition for inhibiting a sudden shift of a highly reliable bit position, central, previous and subsequent n-bit positions with small data transition in only a part of the input (m×n+α) bits of data considering continuity of the part of the input (m×n+α) bits of data having a same value; and
an output bit selector for deciding one of the central, previous and subsequent bit positions as a current bit position to be selected in accordance with a comparison result between preceding and current n-bit positions decided by said output bit position decision circuit, for selecting, from the input (m×n+α) bits of data, the data at the current bit position decided, and for outputting the selected data.
